(19) United States
(12) Patent Application Publication
(10) Pub. No.: US 2012/0006356 A1
(43) Pub. Date: Jan. 12, 2012

(54) Substrate Processing Apparatus, Substrate Processing Method, and Computer-Readable Storage Medium

(75) Inventor: Yuji Kamikawa, Koshi-City (JP)

(73) Assignee: Tokyo Electron Limited

(21) Appl. No.: 13/179,254

(22) Filed: Jul. 8, 2011

(30) Foreign Application Priority Data
Jul. 12, 2010 (JP) 2010-158013

(51) Int. Cl. B08B 3/00

(52) U.S. Cl. 134/10; 134/56 R

(57) ABSTRACT

Disclosed is a substrate processing apparatus in which a liquid state raw material is maintained at a high-temperature and high-pressure fluid state by a cooling mechanism at a first raw material receiving unit, a supplying valve of a raw material supplying path is opened to provide the high-temperature and high-pressure fluid to a processing chamber where a target substrate is disposed, and the target substrate is dried by the high-temperature and high-pressure fluid. A second raw material receiving unit is cooled down below a condensation temperature of the raw material by a second cooling mechanism, the high-temperature and high-pressure fluid in the processing chamber is collected at the second raw material receiving unit by opening a collecting valve. The collected raw material is re-utilized as a raw material supplied from the first raw material receiving unit to the processing chamber.

### CROSS-REFERENCE TO RELATED APPLICATIONS

This application is based on and claims priority from Japanese Patent Application No. 2010-158013, filed on Jul. 12, 2010 with the Japanese Patent Office, the disclosure of which is incorporated herein in its entirety by reference.

### TECHNICAL FIELD

The present disclosure relates to a technology that dries a target substrate (e.g., a substrate to be processed) which is subjected to a process such as a cleaning process, using a high-temperature and high-pressure fluid.

### BACKGROUND

A process of manufacturing a semiconductor device in which a stacking structure of an integrated circuit is formed on the surface of a target substrate, such as a semiconductor wafer (“wafer”), includes a liquid process of processing the wafer surface by using a liquid to remove minute dusts or a native oxide layer on the wafer surface with a cleaning liquid such as a chemical liquid.

For example, a single-type spin cleaning apparatus cleaning the wafer removes the dusts or native oxide layers on the wafer surface by rotating the wafer while supplying, for example, alkaline or acidic chemical solutions to the surface of the wafer by using a nozzle. In this case, after the remaining chemical solutions are removed from the wafer surface by a rinse cleaning using, for example, deionized water (DIW), the wafer surface is dried by a spin dry where the remaining solutions are scattered while rotating the wafer.

However, as the semiconductor device becomes highly integrated, a problem such as so-called “a pattern collapse” has grown seriously in a process of removing the remaining solutions. The pattern collapse is a phenomenon in which the balance of a surface tension horizontally pulling the convex portion is lost, and, as a result, the convex portions collapse toward the side where more solutions remain at the time of drying the remaining solutions on the wafer surface, as the solutions remaining at the left and right sides of a convex portion of the concave/convex portions that form a pattern, are unevenly dried.

As a technique of removing the solutions remaining on the wafer surface while suppressing the pattern collapse, a drying method is known using a supercritical state fluid (“a supercritical fluid”). The viscosity of the supercritical fluid is lower than that of a liquid, and the dissolving ability is higher than that of the liquid. In addition, there is no interface between the supercritical fluid and the liquid or gas which is in an equilibrium state. Therefore, the wafer attached with the liquid is substituted with the supercritical fluid, and thereafter, when the supercritical fluid is changed to a gaseous state, the liquid may be dried without being influenced by the surface tension.

Japanese Application Laid-Open No. 2008-72118 (e.g., paragraphs [0025]-[0029] and [0038]400391 along with FIG. 1) discloses a drying technology in which a substrate cleaned at a cleaning unit is transferred to a drying processing chamber, the pressure of the drying processing chamber is boosted in advance to be more than the critical pressure of the processing fluid (e.g., carbon dioxide in this example) for the drying process, and then, the supercritical fluid is supplied to the drying processing chamber to thereby dry the target substrate. The processing liquid is then discharged from the drying processing chamber and the drying processing chamber is decompressed to the atmospheric pressure completing the drying process.

### SUMMARY

An exemplary embodiment of the present disclosure provides a substrate processing apparatus which includes a processing chamber configured to process a target substrate using a high-temperature and high-pressure fluid; a processing chamber heating mechanism configured to heat the processing chamber in order to maintain the raw material in the processing chamber to be a high-temperature and high-pressure fluid state; a first raw material receiving unit connected to the processing chamber through a raw material supplying path provided with a supplying valve, and configured to receive the raw material with a liquid state; a raw material receiving unit heating mechanism configured to heat the first raw material receiving unit in order to maintain the fluid state raw material to be a high-temperature and high-pressure fluid state; a first cooling mechanism configured to cool the first raw material receiving unit in order to receive the raw material with a liquid state; a second raw material receiving unit connected to the processing chamber through a raw material collecting path provided with a collecting valve, and configured to collect the raw material from the processing chamber; a second cooling mechanism configured to cool the second raw material receiving unit below a condensation temperature of the raw material in order to collect the high-temperature and high-pressure fluid in the processing chamber; and a control unit configured to output a control signal in order to open the supplying valve for supplying the raw material after the liquid state raw material in the first raw material receiving unit becomes a high-temperature and high-pressure state, and to cool the second raw material receiving unit below the condensation temperature of the raw material and open the collecting valve after the high-temperature and high-pressure fluid is supplied to the processing chamber.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a plan view of a cleaning processing system according to an exemplary embodiment of the present disclosure.

FIG. 2 is a longitudinal sectional side view illustrating one example of a cleaning apparatus in the cleaning processing system.

FIG. 3 is a perspective view illustrating a supercritical processing apparatus, according to an exemplary embodiment of the present disclosure.

FIG. 4 is an exploded perspective view illustrating the supercritical processing apparatus.

FIG. 5 is a longitudinal sectional side view illustrating a configuration of a preparing/collecting unit for supercritical fluid installed in the supercritical processing apparatus.

FIG. 6 is a lateral plan view illustrating the preparing/collecting unit.

FIG. 7 is a perspective view illustrating an appearance of the supercritical processing apparatus which is in a state where a cooling mechanism of the preparing/collecting unit is being activated.

FIG. 8 is an explanation diagram illustrating a processing fluid supply and discharge system for supplying and discharging to and from the supercritical processing apparatus.

FIG. 9 is a first explanation diagram illustrating an operation of the supercritical processing apparatus.

FIG. 10 is a second explanation diagram illustrating an operation of the supercritical processing apparatus.

FIG. 11 is an explanation diagram illustrating an internal view of the spiral tube installed in the preparing/collecting unit.

FIG. 12 is an explanation diagram illustrating an example of another configuration of the supercritical processing apparatus.

FIG. 13 is an explanation diagram illustrating an example of yet another configuration of the supercritical processing apparatus.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

Herein, the kind of fluids used as a supercritical fluid for drying the target substrate is not limited to the inexpensive inert gas such as Carbon Dioxide, which is disclosed in Japanese Application Laid-Open No. 2008-72118. For example, the used amount of the supercritical fluid needs to be minimized when IsoPropyl Alcohol (IPA) that requires a process to be discharged and an expensive processing liquid such as Hydro Fluoro Ether (HFE) are used. However, there is no such teaching in Japanese Application Laid-Open No. 2008-72118 as a method for converting a processing liquid to a supercritical liquid or a handling method of a liquid for a drying process discharged from a drying processing chamber. Accordingly, problem still remains as to how to reduce the used amount of the processing liquid.

The present disclosure has been made in an effort to solve the problems described above, and intends to provide a substrate processing apparatus in which a relatively small amount of high-temperature and high-pressure fluid is consumed in a drying process of a target substrate, substrate processing method, and computer-readable storage medium having stored the substrate processing method therein.

According to an embodiment of the present disclosure, there is provided a substrate processing system, which includes: a processing chamber configured to process a target substrate using a high-temperature and high-pressure fluid; a processing chamber heating mechanism configured to heat the processing chamber in order to maintain the raw material in the processing chamber to be a high-temperature and high-pressure fluid state; a first raw material receiving unit connected to the processing chamber through a raw material supplying path provided with a supplying valve, and configured to receive the raw material with a liquid state; a raw material receiving unit heating mechanism configured to heat the first raw material receiving unit in order to maintain the fluid state raw material to be a high-temperature and high-pressure fluid state; a first cooling mechanism configured to cool the first raw material receiving unit in order to receive the raw material with a liquid state; a second raw material receiving unit connected to the processing chamber through a raw material collecting path provided with a collecting valve, and configured to collect the raw material from the processing chamber; a second cooling mechanism configured to cool the second raw material receiving unit below a condensation temperature of the raw material in order to collect the high-temperature and high-pressure fluid in the processing chamber; and a control unit configured to output a control signal in order to open the supplying valve for supplying the raw material after the liquid state raw material in the first raw material receiving unit becomes a high-temperature and high-pressure state, and to cool the second raw material receiving unit below the condensation temperature of the raw material and open the collecting valve after the high-temperature and high-pressure fluid is supplied to the processing chamber.

According to another exemplary embodiment of the present disclosure, there is provided a substrate processing system, which includes: a processing chamber configured to process a target substrate using a high-temperature and high-pressure fluid; a processing chamber heating mechanism configured to heat the processing chamber in order to maintain the raw material in the processing chamber to be a high-temperature and high-pressure fluid state; a raw material receiving unit connected to the processing chamber, and configured to receive the raw material provided to the processing chamber and the raw material collected from the processing chamber; a raw material receiving unit heating mechanism configured to heat the raw material receiving unit in order to maintain the fluid state raw material to be a high-temperature and high-pressure fluid state; a cooling mechanism configured to cool the raw material receiving unit below a condensation temperature of the raw material in order to collect the high-temperature and high-pressure fluid in the raw material receiving unit and receive the high-temperature and high-pressure fluid as a liquid state raw material; and a control unit configured to output a control signal in order to supply the high-temperature and high-pressure fluid in the raw material receiving unit to the processing chamber after the liquid state raw material in the raw material receiving unit becomes a high-temperature and high-pressure state, and to cool the raw material receiving unit below a condensation temperature to collect the high-temperature and high-pressure fluid in the processing chamber at the raw material receiving unit after the high-temperature and high-pressure fluid is supplied to the processing chamber.

In the substrate processing apparatus, the first raw material receiving unit, the second raw material receiving unit, the raw material supply path, the raw material collecting path, the supplying valve, the collecting valve, the first cooling mechanism and the second cooling mechanism may be commonly used by the substrate processing apparatus, and the first and second raw material receiving units may be connected to each other. Further, a liquid layer may be formed on the surface of the target substrate to prevent the surface of the target substrate from being dried, and the raw material may be the same material as the liquid layer. Still further, in the substrate processing apparatus, isopropyl alcohol may be used as the raw material, and a supercritical fluid may be used as the high-temperature and high-pressure fluid. Meanwhile, a spiral tube may be used as the raw material receiving unit.

According to yet another exemplary embodiment of the present disclosure, there is provided a substrate processing method, which includes: heating a first raw material receiving unit containing a raw material of a liquid state, thereby maintaining the liquid state raw material at a high-temperature and high-pressure fluid state; supplying a high-temperature and high-pressure fluid to a processing chamber by connecting the first raw material receiving unit to the processing chamber; heating the processing chamber, thereby maintaining the raw material in the processing chamber at the high-temperature and high-pressure fluid state; processing a target substrate in the processing chamber using the high-temperature and high-pressure fluid supplied from the first raw material receiving unit; collecting the raw material from the processing chamber by cooling a second raw material receiving unit below a condensation temperature of the raw material; and cooling the first raw material receiving unit to receive the raw material with a liquid state.

According to still yet another exemplary embodiment of the present disclosure, there is provided a substrate processing method, which includes: heating a raw material receiving unit containing a raw material of a liquid state, thereby maintaining the liquid state raw material at a high-temperature and high-pressure state; supplying a high-temperature and high-pressure fluid to a processing chamber by connecting the raw material receiving unit to the processing chamber; heating the processing chamber, thereby maintaining the raw material in the processing chamber at a high-temperature and high-pressure fluid state; processing a target substrate in the processing chamber using a high-temperature and high-pressure fluid supplied from the raw material receiving unit; and collecting the raw material from the processing chamber by cooling the raw material receiving unit below a condensation temperature of the raw material, thereby receiving the raw material with a liquid state.

In the substrate processing method, there may be further included a process of transferring the raw material collected at the second raw material receiving unit to the first raw material receiving unit, thereby re-utilizing the collected raw material as the raw material of the high-temperature and high-pressure fluid supplied to the processing chamber. Additionally, the first raw material receiving unit and the second raw material receiving unit may be commonly used by the substrate processing method, high-temperature and high-pressure fluid may use a supercritical fluid, and the processing of the target substrate may be a drying processing of the target substrate.

According to still yet another exemplary embodiment of the present disclosure, there is provided a computer-readable storage medium storing the computer program used in a substrate processing apparatus that dries a target substrate using a high-temperature and high-pressure fluid, where the computer program includes steps of performing the substrate processing method described above.

According to the present disclosure, the high-temperature and high-pressure fluid supplied to the processing chamber to dry the target substrate is collected in a liquid state. Therefore, the amount of the raw material used for drying the target substrate may be suppressed to be a small amount.

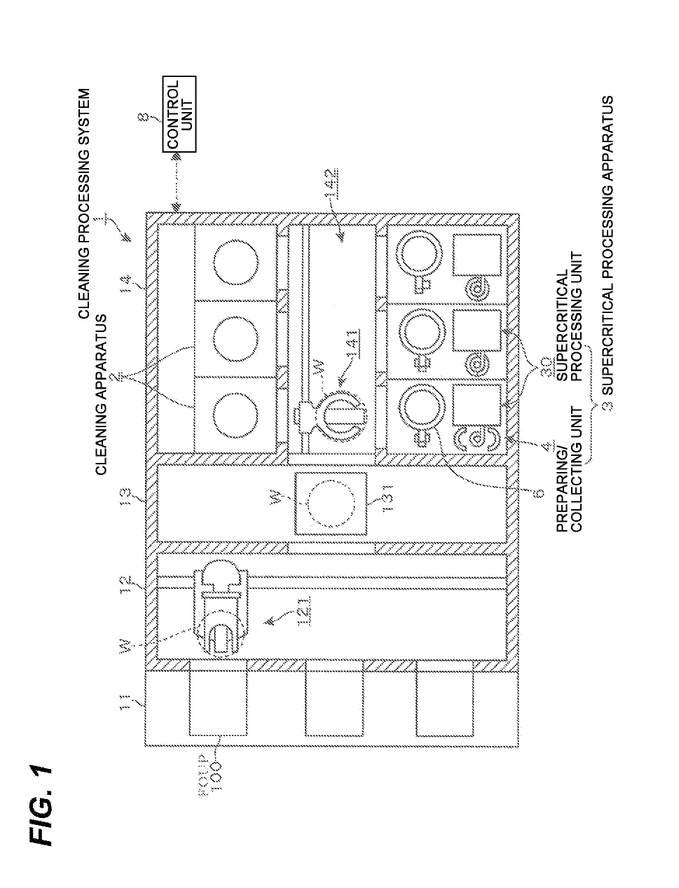

As an example of a substrate processing system having a substrate processing apparatus, a cleaning processing system 1 will be described which includes a cleaning apparatus 2 that performs a cleaning process for a wafer W (a substrate to be processed) by supplying a cleaning liquid to wafer W, and a supercritical processing apparatus 3 that performs a drying process of the wafer W after the cleaning process by using a supercritical fluid of IPA which is in a high-temperature and high-pressure fluid state. FIG. 1 is a transversal plan view illustrating an overall configuration of cleaning processing system 1. Assuming that the left side of the figure is a front side of the system, cleaning processing system 1 includes a loading unit 11 on which a FOUP 100 receiving multiple wafers W having a diameter of, for example, 300 mm, is loaded, a carry-in/out unit 12 for carrying in and out wafer W between FOUP 100 and cleaning processing system 1, and a delivery unit 13 for delivering wafer W between carry-in/out unit 12 and a wafer processing unit 14 at the rear end thereof. Cleaning processing system 1 further includes wafer processing unit 14 where wafer W is sequentially carried into cleaning apparatus 2 and supercritical processing apparatus 3, and is subjected to the cleaning process or the supercritical process. Specifically, cleaning processing system 1 is constituted such that loading unit 11, carry-in/out unit 12, delivery unit 13 and wafer processing unit 14 are connected in this order from the front.

Loading unit 11 is a loading stand capable of loading, for example, four (4) FOUPs 100 and connects each FOUP 100 loaded on the loading stand to carry-in/out unit 12. In carry-in/out unit 12, by an opening/closing mechanism (not shown) installed on a connecting surface with each FOUP 100, an opening/closing door of FOUP 100 is taken off, such that wafer W is transferred between an inner part of FOUP 100 and passing unit 13 by a first transfer mechanism 121. First transfer mechanism 121 freely advances and retreats in a forward and backward directions, freely moves in the lateral direction, freely rotates around the vertical axis, and freely movable up and down. In delivery unit 13 of which the front and rear sides are fitted in carry-in/out unit 12 and wafer processing unit 14, respectively, there is provided a delivery rack 131 serving as a buffer capable of loading, for example, eight (8) sheets of wafers W, and wafer W is transferred between carry-in/out unit 12 and wafer processing unit 14 through delivery rack 131.

In wafer processing unit 14, there is formed a wafer transfer path 142 extending toward forward and backward directions from an opening between passing unit 13 and wafer processing unit 14. In addition, at the left side of wafer transfer path 142 when viewed from the front of wafer transfer path 142, for example, three (3) cleaning apparatuses 2 are arranged along wafer transfer path 142. Likewise, at the right side of wafer transfer path 142, for example, there are arranged three (3) supercritical processing apparatuses 3 which are substrate processing apparatuses according to the exemplary embodiment of the present disclosure. In wafer transfer path 142, a second transfer mechanism 141 is installed transferring wafer W between delivery rack 131, each cleaning apparatus 2 and supercritical processing apparatus 3. In particular, second transfer mechanism 141 can move along wafer transfer path 142, advance and retreat toward cleaning apparatus 2 and supercritical processing apparatus 3 provided at the left and right sides thereof, rotate around the vertical axis, and move up and down. As a result, wafer W may be transferred. Herein, the number of cleaning apparatuses 2 or supercritical processing apparatuses 3 that are disposed in wafer processing unit 14 is not limited to the number exemplified above, but may be selected properly depending on the number of sheets of wafer W processed per unit time or a difference in processing time in cleaning apparatuses 2 and supercritical processing apparatus 3. Further, the layout of cleaning apparatus 2 or supercritical processing apparatus 3 may employ a different arrangement from that of the example shown in FIG. 1.

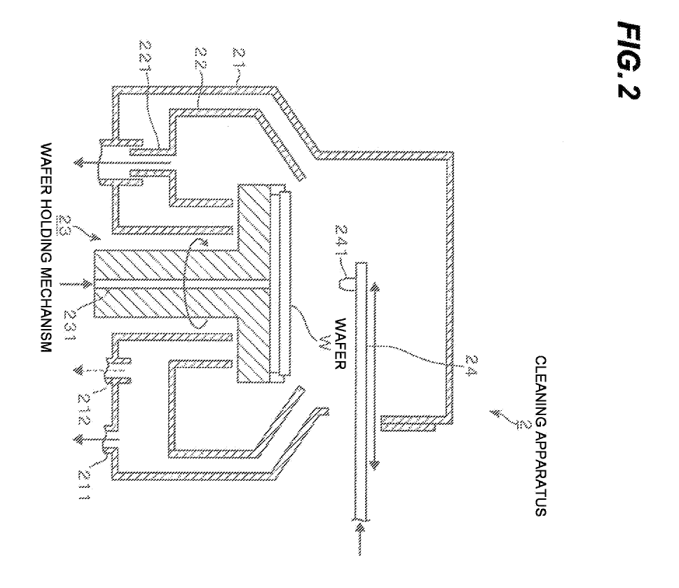

Cleaning apparatus 2 is configured as, for example, a single-type cleaning apparatus which performs cleaning process for each wafer W with a spin cleaning. For example, as shown in a longitudinal sectional side view of FIG. 2, wafer W is held substantially horizontally by a wafer holding mechanism 23 disposed within an external chamber 21 forming a processing space, and wafer holding mechanism 23 is rotated around the vertical axis, thereby rotating wafer W. And, a nozzle arm 24 enters into an upper side of the rotating wafer W, and a chemical liquid and a rinse liquid are supplied from a chemical liquid nozzle 241 installed in the front end thereof in a predetermined order, such that the cleaning process for the surface of wafer W is performed. Further, a chemical liquid supplying path 231 is also formed in wafer holding mechanism 23 and thus a cleaning process for the back-surface of wafer W is performed with the chemical liquid and the rinse liquid supplied from chemical liquid supplying path 231.

The cleaning process is performed, for example, in a following sequence: i) removal of particles or organic contaminated materials with, for example, an SC1 liquid which is an alkaline chemical liquid (a mixed liquid of ammonia and a hydrogen peroxide), ii) rinse cleaning with deionized water (DIW) which is a rinse liquid, iii) removal of a native oxide film with an aqueous solution hydrofluoric acid (hereinafter, referred to as diluted hydrofluoric acid (DHF)) which is an acidic chemical liquid, and iv) rinse cleaning with DIW. These chemical liquids are received in an inner cup 22 disposed in an external chamber 21 or received in external chamber 21, and discharged from drain holes 221 and 211. Further, the atmosphere within external chamber 21 is exhausted from an exhaust port 212.

When the cleaning process with the chemical liquids is completed, wafer holding mechanism 23 stops rotating and IPA is supplied to the surfaces thereof for a dry prevention, thereby substituting the DIW remaining on the front and the back surfaces of wafer W with IPA. Accordingly, the wafer W completed with the cleaning process is delivered, with IPA being adhered to the surfaces thereof, to second transfer mechanism 141 by, for example, a delivery mechanism (not shown) installed in wafer holding mechanism 23, and then is carried out of cleaning apparatus 2.

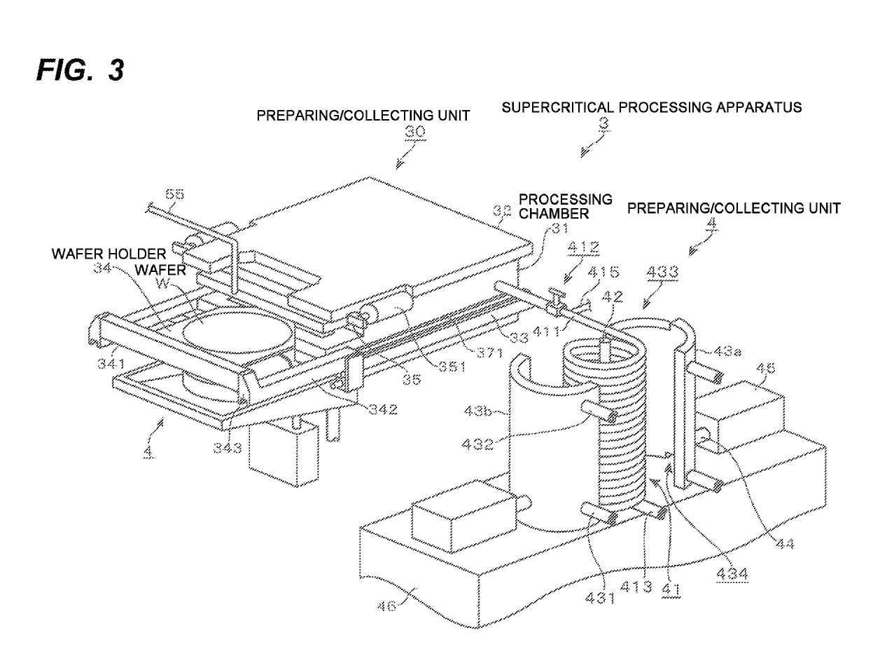

Wafer W completed with the cleaning process in cleaning apparatus 2 is transferred, with the IPA being adhered to the surfaces thereof and being wet, to supercritical processing apparatus 3 and thereafter, a supercritical process is performed in which the liquid remained in the surface of water W is removed by using the supercritical fluid, and wafer W is dried. Hereinafter, the configuration of supercritical processing apparatus 3 according to the exemplary embodiment of the present disclosure will be described with reference to FIGS. 3 to 8. In FIGS. 3, 4 and 7, the configuration will be described by assuming the left side of the figures as a front side.

As shown in FIG. 1, for example, three (3) supercritical processing apparatuses 3, arranged along wafer transfer path 142, are disposed within the cases individually sectionalized, and transfer arm 6 transferring wafer W and supercritical processing apparatus 3 are disposed within each case in this order from the front.

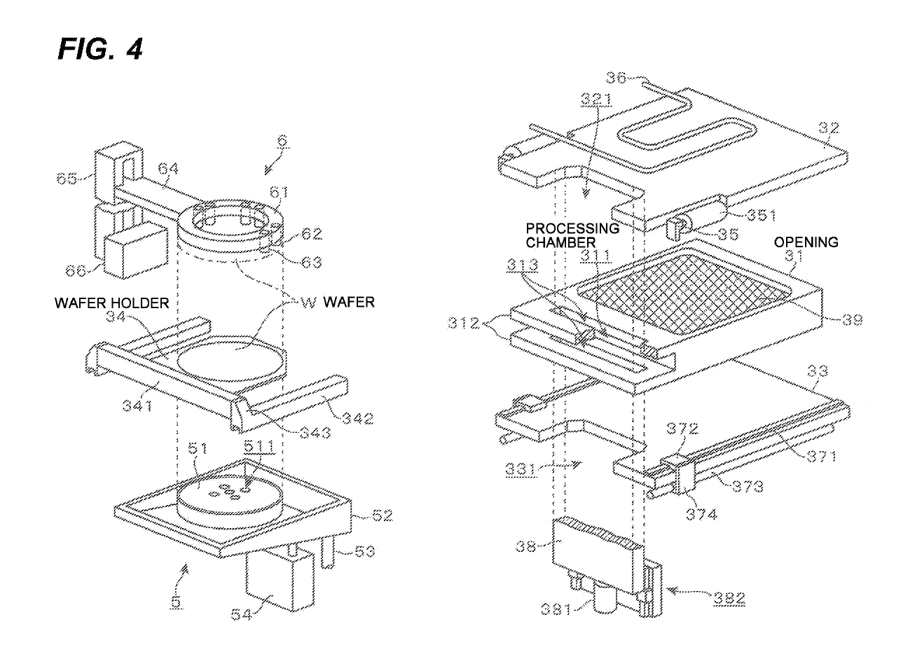

For example, transfer arm 6 is provided with a holding ring 61 for holding wafer W at the front-end of arm member 64 extending in horizontal direction as shown in FIG. 4. Transfer arm 6 is freely movable up and down by elevating mechanism 65 and freely movable forward and backward by moving mechanism 66. In holding ring 61, there is provided, for example, a set of paired picks 62 and 63 adsorbing and maintaining three positions of peripheral circumference of upper surface of wafer W. Specifically, pick 62 is served as a carrying-in pick for holding wafer W where the supercritical process is not yet performed, and pick 63 is served as a carrying-out pick for holding wafer W where the supercritical process has been completed.

As shown in FIG. 3, supercritical processing apparatus 3 includes supercritical processing unit 30 which processes wafer W, and a ready and recovery unit 4 which performs a supply and recovery of the supercritical fluid for supercritical processing unit 30. Supercritical processing unit 30 includes processing chamber 31 in which a supercritical process is performed for drying wafer W by using the supercritical fluid, a wafer holder 34 which delivers wafer W to and from transfer arm 6 and carries received wafer W into and out of processing chamber 31, and cooling mechanism 5 which cools down wafer holder 34 at a delivery position of wafer W.

Processing chamber 31 corresponds to a processing container of supercritical processing apparatus 3 according to the exemplary embodiment of the present disclosure, as shown in exploded perspective view of FIG. 4, and may be constituted with a rectangular shaped pressure-resistant container which is planar in lateral direction. Inside processing chamber 31, there is formed a flat processing space 310 capable of accommodating wafer holder 34 for holding wafer W. When processing wafer W having, for example, a diameter of 300 mm, processing space 310 may be a relatively small and narrow space having a height in the order of several mm to a ten or more mm and a volume in the order of 300 cm³ to 1500 cm³, so that the supercritical fluid may sufficiently flow between wafer W and inner walls of processing chamber 31, and an atmosphere within processing space 310 may also be filled with a supercritical fluid within a short time while IPA adhered to wafer W has not been dried naturally.

Further, a purge gas supply line and an exhaust line (not shown) are connected to processing chamber 31, and an inert gas, such as N₂ gas is supplied to processing space 310 where the processing for wafer W has been completed, such that the IPA remaining in processing space 310 may be purged toward a disaster-prevention facility installed on downstream of the exhaust line.

In front side of processing chamber 31, a long and narrow opening 311 is formed along the left/right directions to carry in and out wafer W, and processing chamber 31 is disposed within the case in such a way that opening 311 is to be directed toward transfer arm 311. In the side of processing chamber 31 where opening 311 is formed, two planar plate-like protrusions 312 are formed to be protruded in lateral direction, and opening 311 is disposed at a position where above and below portions thereof are sandwiched between two protrusions 312. At each of two protrusions 312, fitting holes 313 are formed for fitting lock plate 38 (described below) with being to be directed upward and downward.

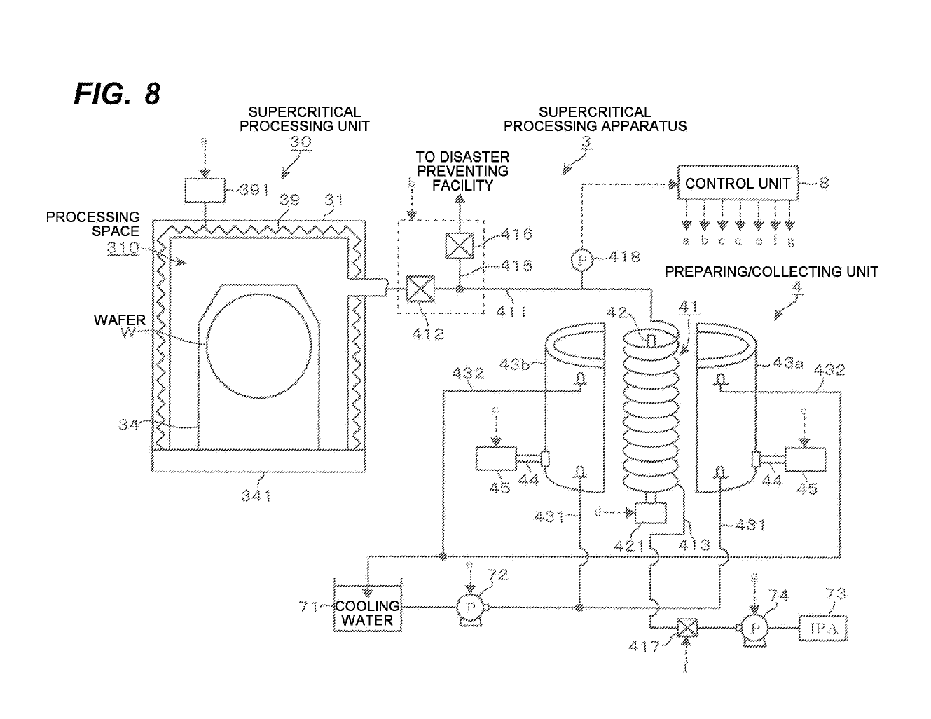

Heater 39 including a resistive heating element such as a tape heater is provided in both the top and bottom surfaces of processing chamber 31 to heat the body of processing chamber 31, such that it is possible to maintain the high-temperature and high-pressure fluid such as a supercritical IPA supplied into processing space 310 in a supercritical state. As schematically shown in FIG. 8, processing chamber 31 is connected with power supply unit 391 and the temperatures of the main body of processing chamber 31 and processing chamber 31 is maintained in the range of 100° C. to 300° C., for example, 270° C., by increasing and decreasing the output of power supply unit 391. Heater 39 corresponds to a heating device for processing chamber 31. Meanwhile, for the convenience of illustration, only heater 39 placed in the upper side of processing chamber 31 is shown in FIG. 4.

Further, upper plate 32 and lower plate 33 are provided in top and bottom surfaces of processing chamber 31 for a thermal insulation of a surrounding atmosphere from heater 39. Upper plate 32 and lower plate 33 are plate-like members formed to cover heater 39 with thermal insulation material (not shown). Further, upper plate 32 and lower plate 33 serve to protect the various driving apparatus installed around processing chamber 31 from heat generated from heater 39, and further to suppress the facilitation of evaporation, caused by the heat generated from heater 39, of IPA adhered to wafer W before a supercritical process.

Cooling tube 36 is provided in top surface of upper plate 32 and bottom surface of lower plate 33 for cooling down upper plate 32 and lower plate 33, and refrigerants, such as cooling water, supplied from a refrigerant supplying unit is flowed through cooling tube 36, such that each of plates 32 and 33 can be cooled down. Meanwhile, for the convenience of illustration, only cooling tube 36 placed in upper plate 32 side is shown in FIG. 4. In front sides of each of plates 32 and 33, cut-out portions 321 and 331 are formed at a position corresponding to protrusion 312 described above, and thus those plates 32 and 33 are not interfered with lock plate 38 which is fitted into fitting hole 313 of protrusion 312.

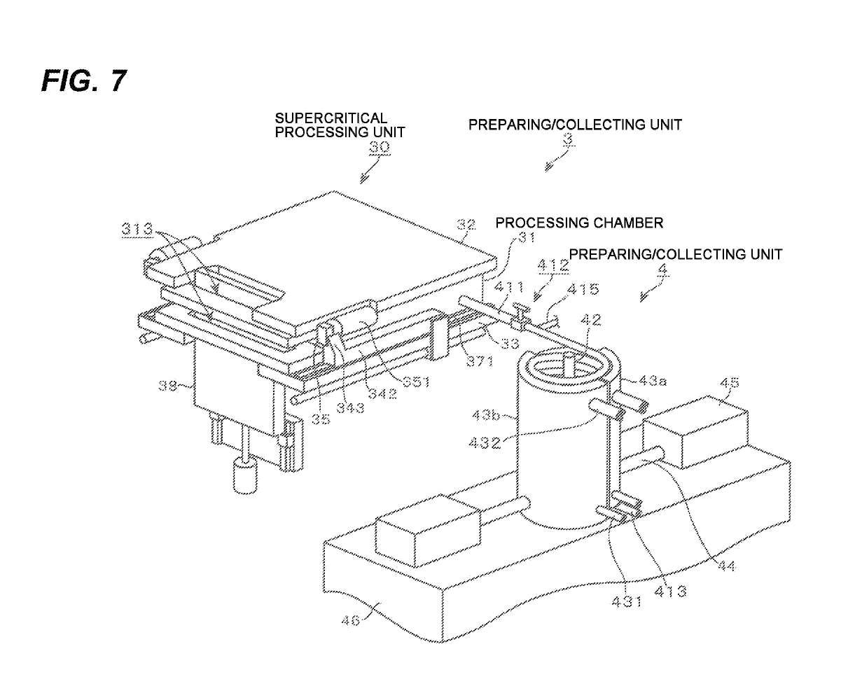

As shown in FIG. 3 and FIG. 7, upper plate 32 and lower plate 33 in the exemplary embodiment of the present disclosure are formed to be wider in width than processing chamber 31 in a lateral direction when viewed from the front side. And, as shown in FIG. 4, at the upper side of both edges of lower plate 33, rail 371 is formed to be extended in forward and backward directions for moving arm member 342 that holds wafer holder 34. Descriptions will follow for arm member 342.

Among reference numerals denoted above rail 371, reference numeral 372 denotes a slider disposed on rail 371, which is connected to arm member 342 and runs on rail 371, reference numeral 373 denotes a driving mechanism including, for example, a rodless cylinder for driving rail 371, and reference numeral 374 denotes a connection member for connecting slider 372 and driving mechanism 373.

Wafer holder 34 is a thin plate-like member configured to be disposed within processing space 310 of processing chamber 31 with maintaining wafer W thereon. Wafer holder 34 is connected to a rectangular pillar-shaped covering member 341 extending in a lateral direction as shown in FIG. 4, and thus wafer holder 34 and covering member 341 are integrally formed. Covering member 341 is formed with a size that can be fitted within a gap of which above and below portions are sandwiched between two protrusions 312 described above, which are protrude from a surface having opening 311 of processing chamber 31 formed thereon in a lateral direction.

Therefore, when wafer holder 34 is carried into processing space 310 of processing chamber 31, covering member 341 can be fitted into the gap between protrusions 312, which is formed above and below portions of the gap, to fill opening 311. In this configuration, in side wall of processing chamber 31 opposed to covering member 341, an O-ring is formed so as to surround opening 311. Accordingly, when opening 311 is filled with covering member 341, the O-ring is pressed by covering member 341 such that an air-tight state is maintained inside of processing space 310.

At both left and right ends of covering member 341, there is formed arm member 342 extending toward processing chamber 31, and a fore-end of arm member 342 is connected with slider 372 described above, such that arm member 342 can run on rail 371 in forward and backward directions. And, as shown in FIG. 3, when slider 371 is moved up to the fore-end of rail 371, wafer holder 34 is withdrawn to a delivery position outside of processing chamber 31 in order to deliver wafer W to and from transfer arm 6. Meanwhile, when slider 371 is moved up to the rear-end of rail 371, as shown in FIGS. 7 and 8, a supercritical process can be performed for wafer W by moving wafer holder 34 up to a processing position within processing chamber 31 (processing space 310).

As shown in FIG. 4, in left and right arm members 342, protrusion 343 protruding upwardly is formed at one end of the front side of arm members 342, which forms a connection portion with covering member 341. Meanwhile, in processing chamber 31 side, for example, lock member 35 is installed at forward areas of both left and right ends of upper plate 32, and lock member 35 is hooked to protrusion 343, such that wafer holder 34 can be fixed to side walls of processing chamber 31 in a pressing down manner. Lock member 35 is freely rotatable by lock cylinder 351. Specifically, as shown in FIG. 3, when the protrusion of lock member 35 is opened in lateral direction, protrusion 343 is opened from a locked state, and as shown in FIG. 7, when the protrusion is directed to downward, protrusion 343 is hooked to lock member 35 and becomes in a hooked state.

Further, on the front side of processing chamber 31, lock plate 38 is provided including a stopper mechanism to stop the opening of covering member 341 which blocks opening 311. When wafer holder 34 is moved to the processing location, lock plate 38 serves to stop the opening of covering member 341 by pressing the front side of covering member 341, which is inserted into the gap between upper and lower protrusions 312, toward the main body of processing chamber 31.

Therefore, lock plate 38 is inserted into fitting holes 313 formed on upper and lower protrusions 312 to move upward and downward direction between the locking location (FIG. 7) that presses covering member 341 and the opening location that opens covering member 341 by being retreated downward from the locking location. In FIGS. 4 and 7, reference numeral 381 represents an elevating mechanism, and reference numeral 382 represents a sliding mechanism which travels a slider connected to, for example, the lower part of lock plate 38 on rails to guide the movement direction of lock plate 38. For the convenience of illustration, lock plate 38 and the elevating mechanism are not shown in FIG. 3.

Further, as shown in FIGS. 3 and 4, at the lower side of wafer holder 34 that moved up to the transfer location of wafer W, there is installed a cooling mechanism 5 for cooling wafer holder 34. Cooling mechanism 5 includes a cooling plate 51 disposed to face the bottom of wafer W disposed on wafer holder 34; and a plurality of discharge holes 511 formed on the plate side of cooling plate 51 to discharge, for example, clean air for cooling.

Further, as shown in FIG. 4, cooling plate 51 is held on a drain gutter 52, and enables to collect IPA flowed down from wafer W and discharge the IPA to drain pipe 53. Drain gutter 52 and cooling plate 51 are configured to freely elevate by elevating mechanism 54, so as to go up to the cooling location at the upper side to cool wafer holder 34 when wafer holder 34 is moved to the transfer location, and then to go down to the lower side of the cooling location after wafer holder 34 is moved to the processing location. Meanwhile, for the convenience of illustration, cooling mechanism 5 is omitted in FIG. 7.

Further, in FIG. 3, reference numeral 55 represents an IPA nozzle for supplying IPA to wafer W transferred to wafer holder 34, and also configured to give a second supply of IPA to wafer W before transferred into the processing chamber 31. As a result, a sufficient amount of IPA is adhered to wafer W so as not to be naturally dried before wafer W is transferred into processing chamber 31.

In processing chamber 31 having the above-identified configuration, there is provided a preparing/collecting unit 4 having both of a function to prepare a supercritical fluid (a high-temperature and high-pressure fluid) of IPA to be supplied to an internal processing space 310 and a function to collect the IPA after the supercritical process. As shown in FIG. 3, preparing/collecting unit 4 prepares IPA in a supercritical state to be supplied to processing chamber 31, and further includes a spiral tube 41 formed such that a pipe is wound in a spiral for collecting the IPA after the processing, a halogen lamp 42 including a heating mechanism for heating spiral tube 41 to make the internal IPA in a supercritical state, cooling jackets 43a and 43b including a cooling mechanism for cooling spiral tube 41 to condensate the IPA supplied to processing chamber 31 in spiral tube 31, and collect the IPA, and a moving mechanism for moving cooling jackets 43a and 43b between the location to cool spiral tube 41 and the location retreated from the cooling location.

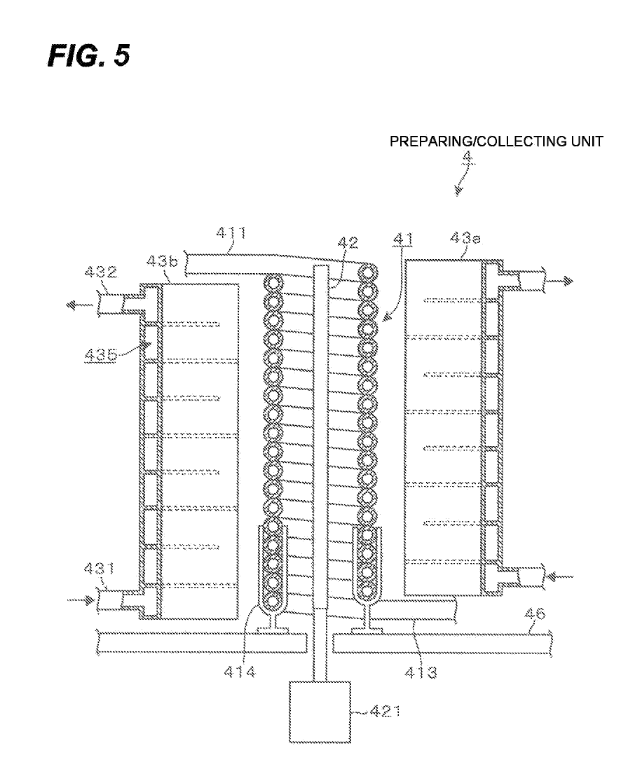

Spiral tube 41 is formed cylindrically by lengthening a piping member made of stainless steel in a spiral in the longitudinal direction, and disposed on a support 46 so that the longitudinal direction becomes the vertical direction. Spiral tube 41 is painted with, for example, a radiant heat-absorbing black paint in order to facilitate absorption of radiant heat from halogen lamp 42, and is wound in a spiral such that pipes adjacent in the longitudinal direction is in contact with each other, as shown in the longitudinal sectional side view of FIG. 5. Thus, by forming a spiral with no gap, it is difficult for radiant heat from halogen lamp 42 to leak outward from a gap between spiral tubes 41.

In FIG. 5, reference numeral 414 represents a fixing member for fixing spiral tube 41 on support 46.

As shown in FIGS. 1 and 3, preparing/collecting unit 4 including spiral tube 41 is disposed in the vicinity of supercritical processing unit. The piping member constituting spiral tube 41 is extended from its upper part toward the side of supercritical processing apparatus 3 and connected to processing chamber 31, and constitutes a connection line 411 with which a raw material supply path and a raw material collect path are in common. In connection line 411, there is interposed a pressure-resistant opening/closing valve 412 with which a supplying valve and a collecting valve are in common, and by which spiral tube 41 and processing chamber 31 are capable of being in communication or blocked. As shown in FIG. 8, from connection line 411, a discharge line 415 is branched off at the upstream location of opening/closing valve 412. Discharge line 415 is configured to discharge IPA in spiral tube 41 toward an external harm-removing facility. In FIG. 8, reference numeral 416 represents a pressure-resistant opening/closing valve by which spiral tube 41 is in communication with or blocked to the disaster-prevention facility.

Further, as shown in FIG. 8, the piping member is extended from the lowermost part of spiral tube 41 to form an IPA receiving line 413. IPA receiving line 413 is connected via pressure-resistant opening/closing valve 417 and a liquid transferring pump 74 to an IPA supplying unit 43 retaining liquid IPA. At the exit of liquid transferring pump 74, a flow control unit (not shown) having a flow control valve and a flow meter is installed to control the amount of IPA supplied from IPA supplying unit to spiral tube 41.

As shown in FIG. 5, halogen lamp 42 is a heating lamp in a bar form disposed upright inside the cylinder constituted by spiral tube 41, which is spaced from the inner wall surface of spiral tube 41 to arrange along with the central axis of the cylinder. The lower part of halogen lamp 42 penetrates the upper panel of support 46 to connect to a power supply unit 421. By the power supplied from power supply unit 421, halogen lamp 42 provides heat, mostly the radiant heat by which spiral tube 41 is heated. From this point of view, halogen lamp 42 corresponds to a heating mechanism for spiral tube 41. Further, according to the examples shown in FIGS. 3 and 7, preparing/collecting unit 4 is disposed as exposed in parallel with supercritical processing unit 30. However, a shield plate may be installed between preparing/collecting unit 4 and supercritical processing unit 30 to shield radiant heat from halogen lamp 42 so that wafer W transferred to wafer holder 34 is not dried before processing.

On the outer wall surface of spiral tube 41, a temperature detection unit (not shown) including a thermocouple is provided to detect temperature of spiral tube 41. In addition, the result of temperature detection is output to a control unit 8, and then fed back to power supply unit 421 as an adjusted amount of power supplied to halogen lamp 42, thereby controlling the heating temperature of each spiral tube 41. Further, as shown in FIG. 8, a pressure gauge 418 is installed in connection line 411 to detect the supercritical state of IPA in spiral tube 41 when heating spiral tube 41.

As shown in FIGS. 3 and 5, cooling jackets 43a and 43b are semi-cylindrical members obtained by longitudinally cutting a cylinder capable of covering an outer circumference of a cylinder formed by spiral tube 41. As shown in FIG. 5, the inside of each of cooling jackets 43a and 43b has a cavity. In the cavity, there is formed a refrigerant flow path 435 that allows a cooling water as a refrigerant to flow from a cooling water introducing line 431 connected to the outer circumference of cooling jackets 43a and 43b to cooling water discharging line 432.

The inner circumference of cooling jackets 43a and 43b constitutes a heat absorbing surface that absorbs heat. The cooling of spiral tube 41 is achieved by contacting the heat absorbing surface with the outer circumference of the cylinder formed by spiral tube 41. As shown in FIG. 8, cooling water introducing line 431 supplying cooling water to each of cooling jackets 43a and 43b, is joined upstream to connect via a liquid transferring pump 72 to a cooling water supplying unit 71 retaining cooling water. Further, cooling water discharging line 432 that discharges the cooling water used in each of cooling jackets 43a and 43b, is also connected to cooling water supplying unit 71, thereby allowing the cooling water to be recycled.

Cooling water supplying unit 71 is connected to a cooling tower or a heat exchanger for cooling (not shown) to pick out the heat collected during the cooling of spiral tube 41, thereby maintaining the cooling water in cooling water supplying unit 71, for example, at 20° C. Further, the exemplary embodiment shown in FIG. 5 is exemplified by cooling jackets 43a and 43b, each of which has one refrigerant flow path 435 formed therein. However, the inside of each of cooling jackets 43a and 43b may be divided into a plurality of cavities, and allow cooling water to flow through refrigerant flow paths 435 formed in each of the cavities, thereby improving the cooling capability. In addition, the refrigerant flowed through refrigerant flow path 435 is not limited by cooling water, but for example, GALDEN (registered trademark) may be used.

Here, in the longitudinal sectional side view shown in FIG. 5, for the convenience of illustration, the directions of longitudinal section of spiral tube 41 and cooling jackets 43a and 43b are different from each other. Likewise, the locations of cooling water introducing lines 431 and cooling water discharging lines 432 arranged in cooling jackets 43a and 43b are also modified and shown to other locations than the actual locations as shown in FIGS. 3 and 7.

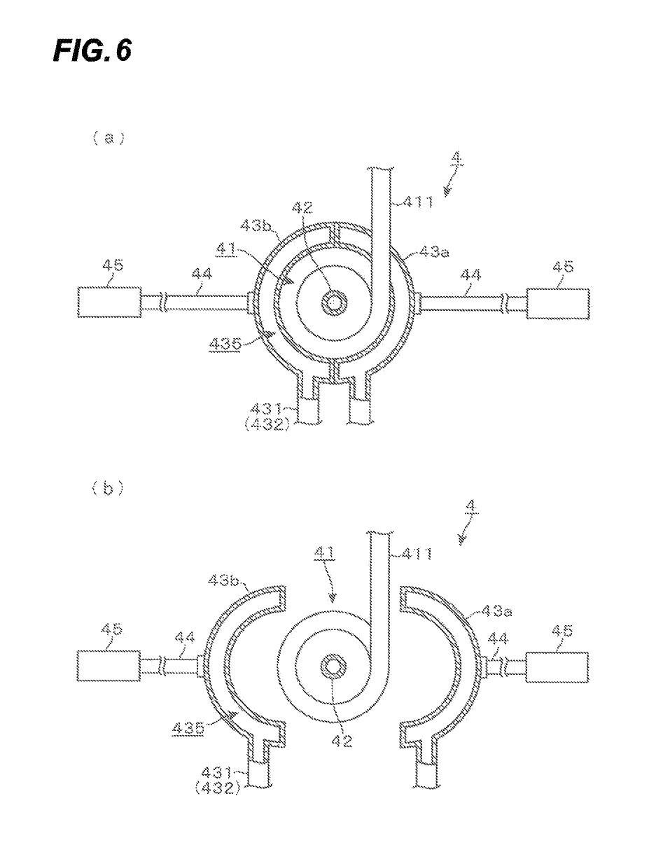

Shafts 44 are connected to the outer circumference of cooling jackets 43a and 43b having configuration described above. At the base end of each shaft 44, a driving unit 45 is installed to move shaft 44 in the axial direction. In addition, by extending each shaft 44, as shown in FIGS. 6(a) and 7, cooling jackets 43a and 43b are allowed to move up to the cooling location where the heat absorbing surface is in contact with spiral tube 41, thereby performing the cooling of spiral tube 41. Further, by retreating each shaft 44, as shown in FIGS. 6(b) and 3, cooling jackets 43a and 43b are allowed to move up to the retreating location where the heat absorbing surface is spaced from spiral tube 41, thereby halting the cooling of spiral tube 41. Here, reference numerals 433 and 434 formed in cooling jacket 43a as shown in FIG. 3, represent notch portions for avoiding any interference between cooling jacket 43a and connection line 411 and receiving line 413 extending from spiral 41 when cooling jacket 43a is moved to the cooling location.

Spiral tube 41 according to the exemplary embodiment corresponds to a first raw material receiving unit which receives IPA of liquid state as a raw material, and changes the IPA from liquid state to supercritical state by heating spiral tube 41. Further, spiral tube 41 is cooled below the condensation temperature of IPA by cooling jackets 43a and 43b, and therefore, also corresponds to a second raw material receiving unit for collecting the IPA supplied to processing chamber 31. Accordingly, in this exemplary embodiment, it is considered that the first raw material receiving unit and the second raw material receiving unit are in common. And, cooling jackets 43a and 43b cooling spiral tube 41 are configured such that a first cooling mechanism cooling the first raw material receiving unit is in common with a second cooling mechanism cooling the second raw material receiving unit.

Cleaning processing system 1 including supercritical processing apparatus 3 having the above-mentioned configuration is connected to control unit 8 as shown in FIGS. 1 and 8. Control unit 8 is constituted by, for example, a computer including a CPU and a memory unit (not shown). A program may be recorded in the memory unit. The program may be implemented with grouped steps (commands) related to the control operations of cleaning processing system 1, cleaning apparatus 2, and supercritical processing apparatus 3, that is, the control operations where wafer W is taken out from FOUP 100 and cleaned in cleaning apparatus 2, subjected to the supercritical process in supercritical processing apparatus 3, and carried into FOUP 100. The program may be stored in memory media such as a hard disk, a compact disk, a magnet optical disk, and a memory card and installed in the computer therefrom.

In particular, relating to supercritical processing unit 3, as shown in FIG. 8, control unit 8 serves to control various operations such as the opening/closing timing of opening/closing valves 412, 416 and 417 installed in lines 411, 415 and 413, respectively, the supplying/halting timing and amount of power from power supply unit 391 to heater 39, or from power supply unit 421 to halogen lamp 43, the moving timing of cooling jackets 43a and 43b by driving unit 45, or the supplying timing or amount of cooling water or IPA by each of liquid transferring pumps 72 and 74. Further, control unit 8 acquires detected results of pressure or temperature in spiral tube 41 from pressure gauge 418 provided in connection line 411 or a temperature detecting unit (not shown) provided in spiral tube 41, and performs heating or cooling of spiral tube 41 on the basis of the results.

An operation of supercritical processing apparatus 3 having the above-mentioned configuration will be described. As described above, when the cleaning process is terminated in cleaning apparatus 2, and wafer W with the dry preventing IPA attached is transferred to second transferring mechanism 141, second transferring mechanism 141 then enters into a case having supercritical processing apparatus 3 capable of receiving wafer W disposed therein, on the basis of, for example, pre-determined processing schedule, and transfers wafer W to transfer arm 6.

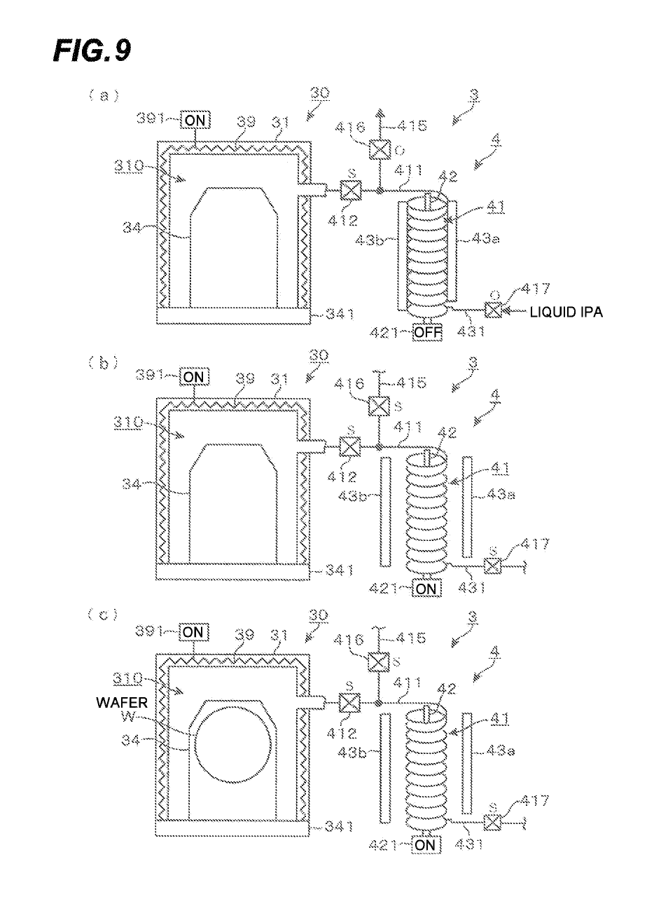

At this time, supercritical processing unit 30 before wafer W is carried-in, is in the state that power supply unit 391 of processing chamber 31 has been in an ON mode to heat the main body of chamber 31 to, for example, 270° C. by heater 39, as shown in FIG. 9(a). Meanwhile, since upper plate 31 and lower plate 33 installed in the upper and lower sides of processing chamber, respectively, have been cooled by cooling tube 36, it is ensured that the surrounding temperature of processing chamber 31 is not over-increased in order to inhibit the evaporation of IPA supplied to the surface of wafer W on wafer holder 34.

Further, in preparing/collecting unit 4, for example, at the timing before the first process begins in supercritical processing apparatus 3, power supply unit 421 of halogen lamp 42 is in an OFF mode, and cooling jacket 43a and cooling jacket 43b are moved to the cooling location to leave spiral tube 41 cooled. In the meantime, in this exemplary embodiment, since liquid transferring pump operates during the operation of supercritical processing apparatus 3, cooling water is always supplied to cooling jackets 43a and 43b.

Further, after opening/closing valve 412 of connection line 411 is “closed” (written as “S” in FIG. 9(a), hereinafter, the same as above), opening/closing valve 416 of discharging line 415 is “opened” (written as “O” in FIG. 9(a), hereinafter, the same as above), and opening/closing valve 417 of cooling water introducing line 431 is “opened”, liquid transferring pump 74 is driven and the IPA is supplied toward spiral tube 41 while detecting the supplying amount by the above-described flow rate adjusting portion. The amount of the IPA supplied to spiral tube 41 is obtained from, for example, a supplying time and a supplying amount per unit time, which may be detected by the flow rate adjusting portion described above.

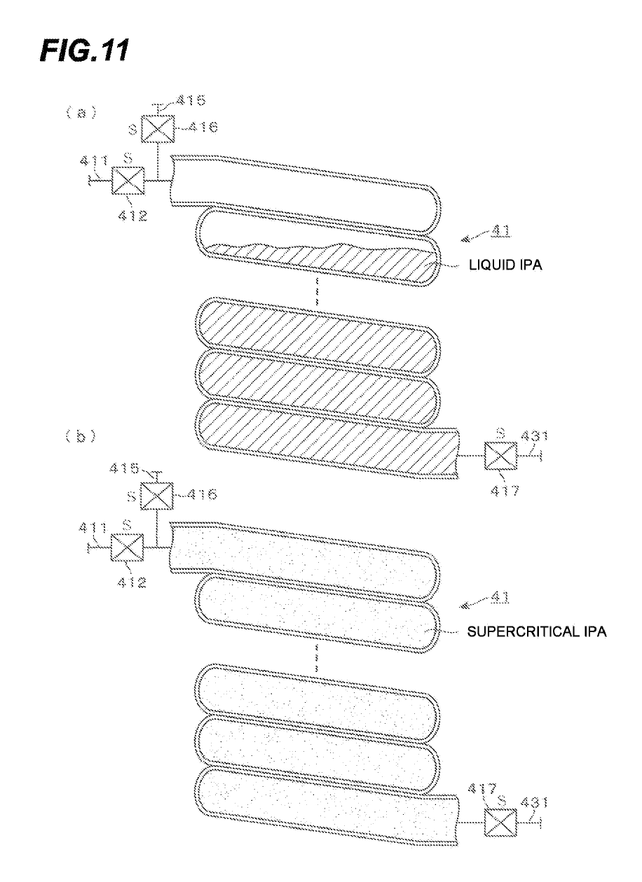

In this way, when supplying the IPA by a predetermined time, liquid transfer pump 74 is stopped, and opening/closing valves 416 and 417 of discharging line 415 and cooling water introducing line 431 are “closed”. As a result, the inner part of spiral tube 41 is filled with liquid IPA up to the height corresponding to the supplying amount as shown in FIG. 11(a). Meanwhile, the upper side space of spiral tube 41, and a space in the vicinity of spiral tube 41 than opening/closing valves 412 and 416 of connection line 411 and discharge line 415 are empty state, which is not filled with the liquid IPA

In this way, when the predetermined amount of the liquid IPA is filled within spiral tube 41, as shown in FIG. 9(b), cooling jackets 43a and 43b are moved to the retreat location, power supply unit 421 is turned ON to apply the power into halogen lamp 42, spiral tube 41 is heated to in the range of 100 to 300, for example, at 270, by heating halogen lamp 42. In this case, since all opening/closing valves 412, 416 and 417 installed in upstream and downstream of spiral tube 41 are closed and the inner part of spiral tube 41 becomes in a sealed atmosphere, when spiral tube 41 is heated, the IPA is vaporized into gas and the pressure within spiral tube 41 is increased according to the expansion of the volume of the IPA.

Furthermore, when the temperature and the pressure of the IPA are raised by continuously heating the IPA in the sealed atmosphere, the temperature and the pressure of the IPA are reached to the critical points, the inner part of spiral tube 41 is filled with a supercritical state IPA, as shown in FIG. 11(b). In this way, a preparation to perform the supercritical process is made, and preparing/collecting unit 4 is on standby while adjusting the output of halogen lamp 42 so as to the temperature and the pressure within spiral tube 41 are maintained to the predetermined values.

Along with these operations, in the side of supercritical processing unit 30, transfer arm 6 transfers wafer W to wafer holder 34, which is on standby in the transfer location, and is retreated from the upper location of wafer holder 34. In addition, the IPA is supplied into the surface of wafer W from IPA nozzle 55, as shown in FIG. 3, the IPA is adhered again. The adhered IPA corresponds to a film for preventing wafer W from being dried.

When the adhesion of IPA is completed, cooling plate 51 is descent to the lower side location, arm member 342 is slid on rail 371 to move wafer holder 34 into the processing location. And, when lock member 35 is rotated and locked by hanging on protrusion 343 and opening 311 of processing chamber 31 is closed by covering member 341, and locking plate 38 is raised up to the locking location from the lower side location to press covering member 341 from the fore side (FIG. 7).

As a result, wafer is carried into processing space 310 of processing chamber 31 at supercritical processing unit 30 side, the supercritical state IPA is prepared within spiral tube 41 at preparing/collecting unit 4 side, and the preparation for performing the supercritical drying is made. Therefore, when the locking of covering member 341 is completed, opening/closing valve 412 of connection line 411 is opened before the IPA adhered on the surface of wafer W is dried, and the supercritical state IPA is supplied toward processing space 310 from spiral tube 41.

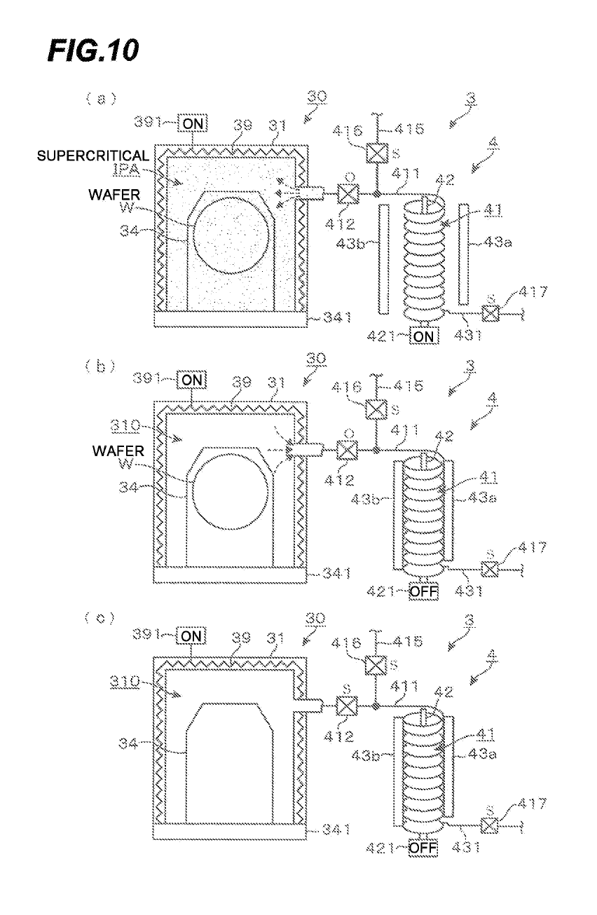

When opening/closing valve 412 is opened, the supercritical IPA in spiral tube 41 is expanded, flows through connection line 411, and flows into processing space 310, as shown in FIG. 10(a). In this case, the IPA may be supplied into processing space 310 while maintaining the supercritical state by (1) setting the temperature and the pressure of the supercritical IPA prepared within spiral tube 41 to be higher enough than the critical temperature and the critical pressure, (2) suppressing the expansion ratio of the supercritical IPA by reducing the volume of processing space 310 within processing chamber 31 and the volume of connection line 411 in vicinity of processing chamber 31 than opening/closing valve 412 as much as possible, and (3) expanding the supercritical IPA into a state which is similar to an isothermal and a uniform pressure expansion, by pre-heating the inner part of processing chamber 31 with heater 39 or increasing the output of halogen lamp 42 so as to maintain the temperature and the pressure in spiral tube 41 before and after opening the opening/closing valve 412 as roughly the same values.

And, when the supercritical IPA supplied into processing space 310 is contacted with the IPA adhered onto wafer W, the adhered IPA is in a supercritical state by taking the heat from the supercritical IPA and being vaporized. As a result, the liquid IPA on the surface of wafer W is being substituted with the supercritical IPA, and since an interface is not formed between the liquid IPA and the supercritical IPA in the equilibrium state, the fluid on the surface of wafer W may be substituted with the supercritical IPA without causing the pattern collapse.

When the predetermined time is elapsed after supplying the supercritical IPA into processing space 310 and the surface of wafer W is in a state that is substituted with the supercritical IPA, power supply unit 421 is turned OFF and the heating of spiral tube 41 by halogen lamp 42 is stopped, as shown in FIG. 10(b). Then, cooling jackets 43a and 43b are moved to the cooling locations, and the temperature of the inner part of spiral tube 41 is cooled so as to be a condensation temperature of IPA or less.

When spiral tube 41 is cooled to condensate the supercritical IPA, the volume of IPA is decreased to lower the pressure within spiral tube 41, while the heating of processing chamber 31 by heater 39 is continued. Thus, the IPA within processing space 310 flows toward spiral tube 41. As a result, the introduced IPA is condensed in turn, then becomes the liquid IPA and is stored into spiral tube 41. And, when a liquid surface is reached at the height of FIG. 11(a), opening/closing valve 412 of connection line 411 may be closed to complete the collecting the IPA within processing space 310. Further, considering the balances of the temperature and the pressure between processing chamber 31 and spiral tube 41, opening/closing valve 412 may be closed after collecting all of possible amount into spiral tube 41. In this case, when the liquid surface of the IPA within spiral tube 41 exceeds the predetermined height location, the level of the liquid surface may be adjusted by opening opening/closing valve 416 at discharging line 415 side to exhaust some of the IPA toward a disaster-prevention facility. In these exemplary embodiments, the height location of the liquid surface of the IPA may be detected by detecting the liquid surface of the IPA. The detection may be performed, for example, by providing a viewing window having a pressure resistance in the wall surface at a location that the liquid surface of the IPA is reached, and by a liquid level meter of infrared type.

In this way, when the IPA is collected in spiral tube 41 in a liquid state, the pressure of processing chamber 31 is decreased step by step. Meanwhile, since the temperature in processing space 310 is maintained at a higher temperature than the boiling point (82.4) of the IPA at atmospheric pressure, the IPA within processing space 310 is changed into a gas state from a supercritical state. In this case, since an interface is not formed between the supercritical state and gas state, wafer W may be dried without applying a surface tension to the pattern formed onto the surface.

When the supercritical process of wafer W by way of the above processes is completed, N₂ gas is supplied to the discharging line from a purge gas supply line (not shown) to perform a purge process so as to exhaust the gas state IPA remained in processing space 310. And then, when the purge process is completed by supplying N₂ gas for a predetermined time, locking plate 38 is descent to the lower location to release the hanging state of protrude unit 343 by lock member 35. Then, wafer holder 34 is moved to the transferring location, wafer W in which the supercritical process thereof is completed, is adsorbed and maintained with carrying out pick 63 of transfer arm 6 for carrying out, and is transferred to second transferring mechanism 141 at wafer transfer path 142 side. Then, wafer W is transferred to first transferring mechanism 121 through carry-out rack 43 and received in FOUP 100 by passing through an opposite path to that in the carrying-in of wafer W, thereby completing a series of operations for wafer W.

Meanwhile, cooling jackets 43a and 43b are moved to the retreat locations at supercritical processing apparatus 3 side as shown in FIG. 9(b), halogen lamp 42 is heated, the IPA collected in spiral tube 41 is in the supercritical state, and the timing that next wafer W is carried in processing chamber 31 is waited.

Supercritical processing apparatus 3 according to the exemplary embodiment of the present disclosure provides the following effects. The supercritical IPA supplied to processing chamber 31 to dry wafer W is collected at a liquid state. Therefore, it is possible to re-utilize the collected IPA as a supercritical IPA, thereby suppressing the amount of the IPA consumed in the processing for wafer W at each time to a small amount near to zero. Here, the amount excludes that of the IPA which is adhered to wafer W and introduced into processing space 310, or that of the IPA which is purged in processing space 310.

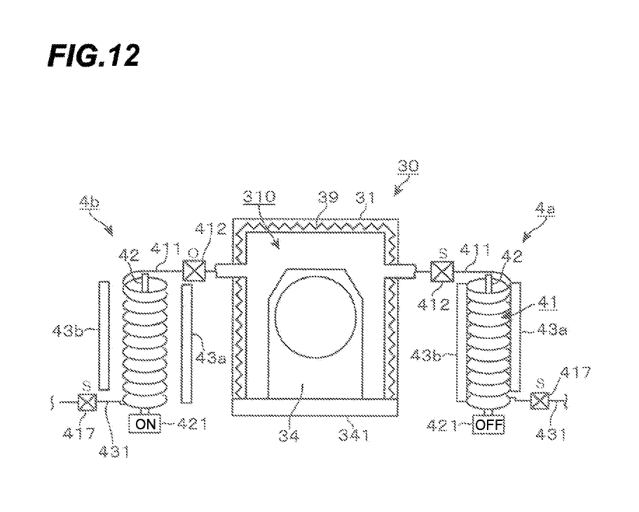

Here, the number of preparing/collecting unit 4 connected to supercritical processing unit 30 is not limited to one, and two preparing/collecting units 4a and 4b may be connected to common supercritical processing unit 30, for example, as shown in FIG. 12. In this way, by connecting a plurality of preparing/collecting units 4a and 4b to supercritical processing unit 30, preparing/collecting units 4a and 4b may be used alternatively in a way that the supercritical IPA supplied from one preparing/collecting unit 4a is collected in other preparing/collecting unit 4b, and the IPA collected in other preparing/collecting unit 4b is supplied into processing space 310 in a supercritical state.

By cooling spiral tube 41 of other side of preparing/collecting units 4b or 4a along with the operations in which the supercritical IPA is prepared at one side of preparing/collecting units 4a or 4b, and by performing a supercritical process for wafer W in processing space 310, the collecting time of the IPA may be shortened to increase the throughput number of wafer W per unit time. Here, when performing the supplying the supercritical IPA and the cooling of spiral tube 41 at other side in parallel, opening/closing valve 412 of connection line 411 connected to spiral tube 41 being cooled is in a closed state.

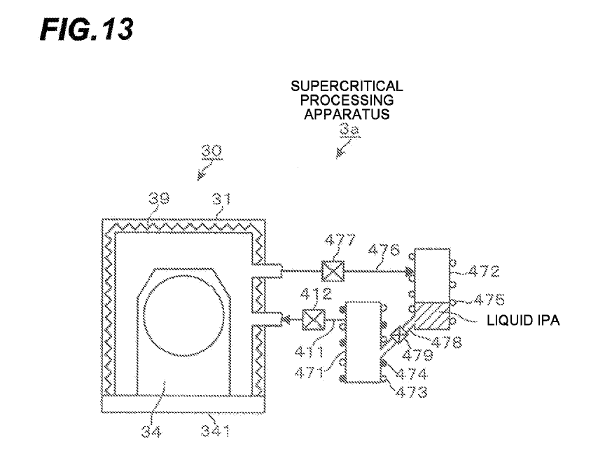

Further, in each exemplary embodiment as shown in FIGS. 3 and 12, as described above, spiral tube 41 has both a role as the first raw material receiving unit that prepares the supercritical state IPA and a role as the second raw material receiving unit that collects the liquid state IPA by cooling spiral tube 41 to the condensation temperature of IPA or less. In contrast, in supercritical processing apparatus 3 as shown in FIG. 13, preparing chamber 471 that is the first raw material receiving unit and collecting chamber 472 that is the second raw material receiving unit are formed in separate members, and preparing chamber 471 and collecting chamber 472 are connected each other by connection line 478. In supercritical processing apparatus 3a as shown in FIG. 13, a component similar to that of supercritical processing apparatus 3 according to the first exemplary embodiment shown in FIGS. 3 to 8 is disclosed as the same reference symbol as that presented in FIGS. 3 to 8.

In the present exemplary embodiment, preparing chamber 471 or collecting chamber 472 is constituted with a cylindrical container, and each of chambers 471 and 472 is provided with cooling tube 473 and 475, which are configured to cool each of chambers 471 and 472 by flowing cooling agent therethrough, and to be the first and second cooling mechanisms, respectively. Further, preparing chamber 471 is provided with heating coil 474, which is a heating device for preparing chamber 471 that heats preparing chamber 471 by an inductance heating and makes the IPA thereof in a supercritical state. In drawings, reference numeral 477 represents the IPA collecting line from processing space 310, reference numeral 478 represents the connection line to connect preparing chamber 471 with collecting chamber 472, and references numeral 477 and 479 represent opening/closing valves of these lines 476 and 478.

As a method for transferring the liquid IPA collected by collecting chamber 472 into preparing chamber 471, connection line 478 may be provided with a pump for supplying liquid. Further, collecting chamber 472 may be disposed at a higher location than preparing chamber 471, and the liquid IPA may be transferred using a head of the liquid IPA, as shown in FIG. 13.

Further, wafer holder 34 includes a thin plate-like member on which wafer W is loaded in the exemplary embodiment in FIGS. 3 and 4, but wafer holder 34 may include a dish-like shape that forms a liquid storing portion of the IPA within the dish-like shape to immerse wafer in the liquid storing portion. As described above, since processing space 310 is pre-heated to about 100 to 300, the situation that the IPA is dried before starting the processing by the supercritical IPA may be prevented.

In this way, when wafer W is carried in processing chamber 31 while immersing wafer W in the IPA, it is not limited to a case in which wafer W is held in wafer holder 34 in a lateral arrangement state, as shown in FIG. 3. For example, wafer holder 34 may be constituted with an elongated cup-shaped chamber in longitudinal direction, so that wafer W can be immersed in the liquid IPA in longitudinal arrangement state. In this case, processing chamber 31 has a shape which is elongated in longitudinal direction corresponding to the shape of wafer holder 34. In addition, in this case, a plurality of wafers W may be held in wafer holder 34.

Further, the raw material of high-temperature and high-pressure fluid that is used to dry wafer W is not limited to the IPA, but other type of fluid such as Hydro Fluoro Ether (HFE) may be used. Further, high-temperature and high-pressure state is not limited to the supercritical state. The technical scope of the present disclosure includes that wafer W may be dried by using a sub-critical fluid by changing the liquid of raw material into a sub-critical state (for example, with a range of 100 to 300 in temperature, and a range of 1 MPa to 3 MPa in a case of the IPA).

Furthermore, the processing which is performed in the present disclosure is not limited to the dry processing to remove the liquid on the surface of wafer W. For example, the present disclosure may be applied to a cleaning and drying process that performs a removing process of a resist film from wafer W and a drying process of wafer W in a lump where the removing is performed by connecting the supercritical state IPA with wafer W patterned by the resist film.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A substrate processing apparatus comprising:
a processing chamber configured to process a target substrate using a high-temperature and high-pressure fluid;
a processing chamber heating mechanism configured to heat the processing chamber in order to maintain raw material in the processing chamber to be a high-temperature and high-pressure fluid state;
a first raw material receiving unit connected to the processing chamber through a raw material supplying path provided with a supplying valve, and configured to receive the raw material with a liquid state;
a raw material receiving unit heating mechanism configured to heat the first raw material receiving unit in order to maintain the fluid state raw material to be a high-temperature and high-pressure fluid state;
a first cooling mechanism configured to cool the first raw material receiving unit in order to receive the raw material with a liquid state;
a second raw material receiving unit connected to the processing chamber through a raw material collecting path provided with a collecting valve, and configured to collect the raw material from the processing chamber;
a second cooling mechanism configured to cool the second raw material receiving unit below a condensation temperature of the raw material in order to collect the high-temperature and high-pressure fluid in the processing chamber; and
a control unit configured to output a control signal in order to open the valve for supplying the raw material after the liquid state raw material in the first raw material receiving unit becomes a high-temperature and high-pressure state, and to cool the second raw material receiving unit below the condensation temperature of the raw material and open the collecting valve after the high-temperature and high-pressure fluid is supplied to the processing chamber.

2. A substrate processing apparatus comprising:
a processing chamber configured to process a target substrate using a high-temperature and high-pressure fluid;
a processing chamber heating mechanism configured to heat the processing chamber in order to maintain raw material in the processing chamber to be a high-temperature and high-pressure fluid state;
a raw material receiving unit connected to the processing chamber, and configured to receive the raw material provided to the processing chamber and the raw material collected from the processing chamber;
a raw material receiving unit heating mechanism configured to heat the raw material receiving unit in order to maintain the fluid state raw material to be a high-temperature and high-pressure fluid state;
a cooling mechanism configured to cool the raw material receiving unit below a condensation temperature of the raw material in order to collect the high-temperature and high-pressure fluid in the raw material receiving unit and receive the high-temperature and high-pressure fluid as a liquid state raw material; and
a control unit configured to output a control signal in order to supply the high-temperature and high-pressure fluid in the raw material receiving unit to the processing chamber after the liquid state raw material in the raw material receiving unit becomes a high-temperature and high-pressure state, and to cool the raw material receiving unit below a condensation temperature to collect the high-temperature and high-pressure fluid in the processing chamber at the raw material receiving unit after the high-temperature and high-pressure fluid is supplied to the processing chamber.

3. The substrate processing apparatus of claim 1, wherein the first raw material receiving unit, the second raw material receiving unit, the raw material supply path, the raw material collecting path, the supplying valve, the collecting valve, the first cooling mechanism and the second cooling mechanism are commonly used by the substrate processing apparatus.

4. The substrate processing apparatus of claim 1, wherein the first and second raw material receiving units are connected to each other.

5. The substrate processing apparatus of claim 1, wherein a liquid layer is formed on the surface of the target substrate to prevent the surface of the target substrate from being dried.

6. The substrate processing apparatus of claim 5, wherein the raw material is the same material as the liquid layer.

7. The substrate processing apparatus of claim 1, wherein the raw material is isopropyl alcohol.

8. The substrate processing apparatus of claim 1, wherein the high-temperature and high-pressure fluid is a supercritical fluid.

9. The substrate processing apparatus of claim 1, wherein the raw material receiving unit is a spiral tube.

10. A substrate processing method comprising:
heating a first raw material receiving unit containing a raw material of a liquid state, thereby maintaining the liquid state raw material at a high-temperature and high-pressure fluid state;
supplying a high-temperature and high-pressure fluid to a processing chamber by connecting the first raw material receiving unit to the processing chamber;
heating the processing chamber, thereby maintaining the raw material in the processing chamber at the high-temperature and high-pressure fluid state;
processing a target substrate in the processing chamber using the high-temperature and high-pressure fluid supplied from the first raw material receiving unit;
collecting the raw material from the processing chamber by cooling a second raw material receiving unit below a condensation temperature of the raw material; and
cooling the first raw material receiving unit to receive the raw material with a liquid state.

11. A substrate processing method comprising:
heating a raw material receiving unit containing a raw material of a liquid state, thereby maintaining the liquid state raw material at a high-temperature and high-pressure state;
supplying a high-temperature and high-pressure fluid to a processing chamber by connecting the raw material receiving unit to the processing chamber;
heating the processing chamber, thereby maintaining the raw material in the processing chamber at a high-temperature and high-pressure fluid state;
processing a target substrate in the processing chamber using a high-temperature and high-pressure fluid supplied from the raw material receiving unit; and
collecting the raw material from the processing chamber by cooling the raw material receiving unit below a condensation temperature of the raw material, thereby receiving the raw material with a liquid state.

12. The substrate processing method of claim 10, further comprising transferring the raw material collected at the second raw material receiving unit to the first raw material receiving unit, thereby re-utilizing the collected raw material as the raw material of the high-temperature and high-pressure fluid supplied to the processing chamber.

13. The substrate processing method of claim 10, wherein the first raw material receiving unit and the second raw material receiving unit are commonly used by the substrate processing method.

14. The substrate method of claim 10, wherein the high-temperature and high-pressure fluid is a supercritical fluid.

15. The substrate method of claim 10, wherein the processing of the target substrate is a drying processing of the target substrate.

16. A computer-readable storage medium storing a computer program used in a substrate processing apparatus that dries a target substrate using a high-temperature and high-pressure fluid, wherein the program includes steps of performing the substrate processing method according to claim 10.
